(19) United States
(12) Patent Application Publication
(10) Pub. No.: US 2017/0228136 A1
(43) Pub. Date: Aug. 10, 2017

(54) CONTENT PROVIDING METHOD, CONTENT PROVIDING APPARATUS, AND COMPUTER PROGRAM STORED IN RECORDING MEDIUM FOR EXECUTING THE CONTENT PROVIDING METHOD

(71) Applicant: LINE Corporation, Tokyo (JP)

(72) Inventor: Jin Hong KIM, Seongnam-si (KR)

(73) Assignee: LINE Corporation, Tokyo (JP)

(21) Appl. No.: 15/405,633

(22) Filed: Jan. 13, 2017

(30) Foreign Application Priority Data
Feb. 5, 2016 (KR) 10-2016-0014886

(51) Int. Cl. G06F 3/0484; G06F 3/0482; G06F 3/0488

(52) U.S. Cl. CPC G06F 3/04845; G06F 3/04883; G06F 3/0482

(57) ABSTRACT

A non-transitory computer readable medium stores computer-executable instructions that, when executed by one or more processors, cause the one or more processors to perform operations including obtaining a first input with respect to a first thumbnail image displayed on a display; displaying, on the display, a first enlarged image corresponding to the first thumbnail image according to the first input; obtaining a second input with respect to a second thumbnail image, wherein the second input is continuative to the first input; and updating the first enlarged image displayed on the display to a second enlarged image corresponding to the second thumbnail image.

### CROSS-REFERENCE TO RELATED APPLICATION

This application claims priority under 35 U.S.C. §119 to Korean Patent Application No. 10-2016-0014886 filed on Feb. 5, 2016, in the Korean Intellectual Property Office, the entire contents of which are incorporated herein by reference.

### BACKGROUND

1. Field

One or more embodiments relate to a content providing method, a content providing apparatus, and a computer program stored in a recording medium for executing the content providing method.

2. Description of the Related Art

This section provides background information related to the present disclosure which is not necessarily prior art.

According to rapid developments in information and communication technology, various types of terminals, such as mobile communication terminals and personal computers (PCs), have been realized to perform various functions.

For example, a mobile communication terminal has recently been realized to perform, in addition to a basic voice communication function, various functions, such as a data communication function, an image or video capturing function by using a camera, a music or video file reproducing function, a game playing function, and a broadcast watching function.

Technology development for expanding functions executable in such terminals is being continuously conducted based not only on hardware improvements, but also on software improvements.

Recently, such terminals surpass PCs in terms of performance, and accordingly, not only pictures and videos, but also various objects recognizable by a PC, such as documents and text, are handled by the terminals, and an amount of content stored in the terminals is increasing. Accordingly, there is an increasing necessity for an efficient method of managing content.

### SUMMARY

This section provides a general summary of the disclosure, and is not a comprehensive disclosure of its full scope or all of its features.

According to at least some example embodiments, a non-transitory computer readable medium stores computer-executable instructions that, when executed by one or more processors, cause the one or more processors to perform operations including obtaining a first input with respect to a first thumbnail image displayed on a display; displaying, on the display, a first enlarged image corresponding to the first thumbnail image according to the first input; obtaining a second input with respect to a second thumbnail image, wherein the second input is continuative to the first input; and updating the first enlarged image displayed on the display to a second enlarged image corresponding to the second thumbnail image.

The operations may further include displaying the first thumbnail image and the second thumbnail image in a first display region, and determining the second input based on the first display region, the displaying of the first enlarged image includes displaying the first enlarged image in a second display region, and the updating of the first enlarged image includes displaying the second enlarged image in the second display region.

The operations may further include displaying the second display region to overlap the first display region, and displaying the first enlarged image or the second enlarged image, which is displayed in the second display region, in a region where the first and second display regions overlap.

The operations may further include obtaining a third input with respect to the second thumbnail image, wherein the third input is continuative to the second input; and displaying, in the first display region, at least a part of second content according to the third input, wherein the second content corresponds to content corresponding to the second thumbnail image or the second enlarged image.

The operations may further include displaying a third thumbnail image in the first display region, obtaining a fourth input with respect to the third thumbnail image, wherein the fourth input is continuative to the second input; updating the second enlarged image displayed in the second display region to a third enlarged image corresponding to the third thumbnail image; obtaining a third input with respect to the third thumbnail image, wherein the third input is continuative to the fourth input; and displaying, in the first display region, at least a part of third content according to the third input, wherein the third content corresponds to content corresponding to the third thumbnail image or the third enlarged image, and the obtaining of the fourth input and the updating to the third enlarged image may be repeatedly performed.

The operations may further include setting the second display region to be a blank.

The second content may be one of a picture, a video, text, and a document.

The first thumbnail image and the second thumbnail image may each one of a thumbnail image of the picture, a scene in the video, an image including a part of the text, and an image of a part of the document.

The third input may be an input on the display displaying the first display region and the second display region, and may be one of an input including a plurality of different touch pressures, an input moving in one direction at at least a first speed, an input in which a plurality of inputs are repeated within a first time period, and an input continued for a first period of time.

The first input may be an input on the display displaying the first display region and the second display region, and may be one of an input including a plurality of different touch pressures and an input continued for a first period of time.

According to at least some example embodiments, a content providing method includes obtaining a first input with respect to a first thumbnail image displayed on a display; displaying, on the display, a first enlarged image corresponding to the first thumbnail image according to the first input; obtaining a second input with respect to a second thumbnail image, wherein the second input is continuative to the first input; and updating the first enlarged image displayed on the display to a second enlarged image corresponding to the second thumbnail image.

The content providing method may further include displaying the first thumbnail image and the second thumbnail image in a first display region; and determining the second input based on the first display region, the displaying of the first enlarged image including displaying the first enlarged image in a second display region, and the updating of the first enlarged image including displaying the second enlarged image in the second display region.

The content providing method may further include obtaining a third input with respect to the second thumbnail image, wherein the third input is continuative to the second input; and displaying, in the first display region, at least a part of second content according to the third input, wherein the second content may correspond to content corresponding to the second thumbnail image or the second enlarged image.

The content providing method may further include displaying a third thumbnail image in the first display region; obtaining a fourth input with respect to the third thumbnail image, wherein the fourth input is continuative to the second input; updating the second enlarged image displayed in the second display region to a third enlarged image corresponding to the third thumbnail image; obtaining a third input with respect to the third thumbnail image, wherein the third input is continuative to the fourth input; and displaying, in the first display region, at least a part of third content according to the third input, wherein the third content may correspond to content corresponding to the third thumbnail image or the third enlarged image, and the obtaining of the fourth input and the updating to the third enlarged image may be repeatedly performed.

The content providing method of claim 14, may further include setting the second display region to be a blank.

According to at least some example embodiments, a content providing apparatus may include a controller configured to receive, from a user terminal, information about a first input with respect to a first thumbnail image displayed on a display of the user terminal, provide, to the user terminal, a first enlarged image corresponding to the first thumbnail image by referring to the information about the first input, receive information about a second input with respect to a second thumbnail image displayed on the display, wherein the second input is continuative to the first input, and provide, to the user terminal, a second enlarged image corresponding to the second thumbnail image by referring to the information about the second input.

The controller may be further configured to receive information about a third input of the user with respect to the second thumbnail image displayed on the display, wherein the third input is continuative to the second input; and provide, to the user terminal, second content by referring to the information about the third input, wherein the second content is content corresponding to the second thumbnail image or the second enlarged image.

The content providing apparatus of claim 16, wherein the controller is further configured to receive information about a fourth input with respect to a third thumbnail image displayed on the display, wherein the fourth input is continuative to the second input; provide, to the user terminal a third enlarged image corresponding to the third thumbnail image by referring to the information about the fourth input; receive information about a third input with respect to the third thumbnail image displayed on the display, wherein the third input is continuative to the fourth input; and provide, to the user terminal, third content by referring to the information about the third input, wherein the third content corresponds to the third thumbnail image or the third enlarged image, and the receiving of the information about the fourth input and the providing of the third enlarged image are repeatedly performed.

The third input may be an input on the display of the user terminal, and may be one of an input including a plurality of different touch pressures, an input moving in one direction at at least a first speed, an input in which a plurality of inputs are repeated within a first time, and an input continued for a first period of time.

The first input may be an input on the display of the user terminal, and may be one of an input including a plurality of different touch pressures and an input continued for a first period of time.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIGS. 1 and 2 are diagrams of a user terminal according to at least one example embodiment;

FIG. 3 is a flowchart of a content providing method performed by a user terminal, according to at least one example embodiment;

FIG. 4 is a diagram of a content providing system according to at least one example embodiment;

FIG. 5 is a block diagram of a content providing apparatus included in a server of FIG. 4;

FIG. 6 is a flowchart of an information processing method performed between a server and a user terminal;

FIG. 7 illustrates a screen for obtaining an input of a user with respect to a thumbnail image displayed on a display of a user terminal, according to at least one example embodiment;

FIG. 8 illustrates a screen in which a first enlarged image is displayed on a display of a user terminal according to a first input of a user;

FIGS. 9A through 9C illustrate a screen for describing processes of obtaining a second input continuative to a first input; and

FIG. 10 illustrates a screen in which content corresponding to a third thumbnail image is displayed in a first display region.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those of ordinary skill in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element, there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, a central processing unit (CPU), a controller, an arithmetic logic unit (ALU), a digital signal processor, a microcomputer, a field programmable gate array (FPGA), a system-on-chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, a CPU, a controller, an ALU, a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording media, including tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such a separate computer readable storage medium may include a universal serial bus (USB) flash drive, a memory stick, a Blu-ray/DVD/CD-ROM drive, a memory card, and/or other similar computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other similar medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be described as being implemented and/or embodied by one computer processing device; however, one of ordinary skill in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different to that of the methods described, and/or components such as the described system, architecture, devices, circuit, and the like, may be connected or combined to be different from the above-described methods, or results may be appropriately achieved by other components or equivalents.

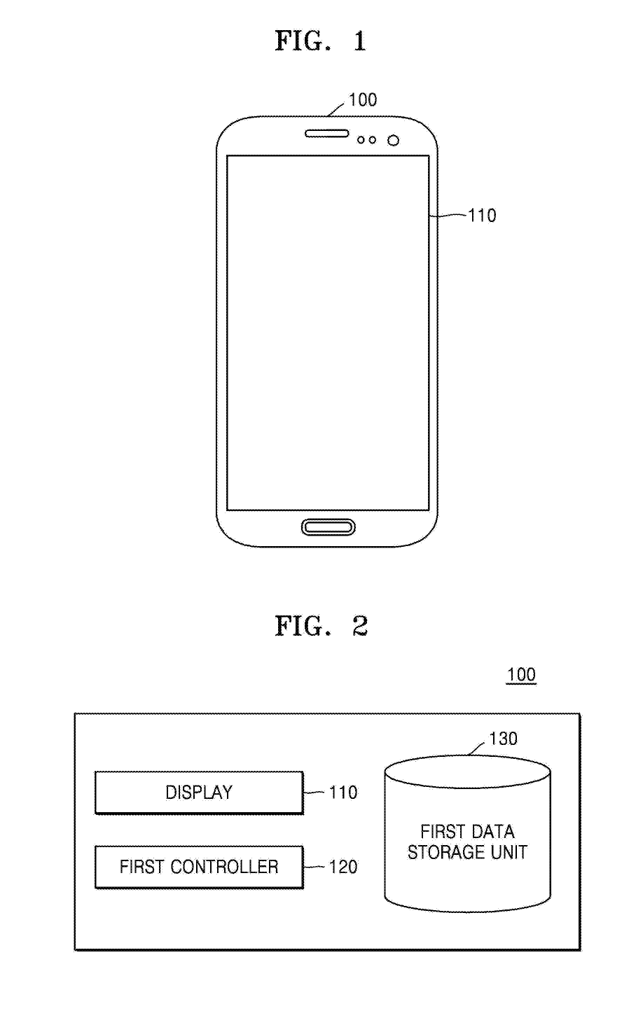

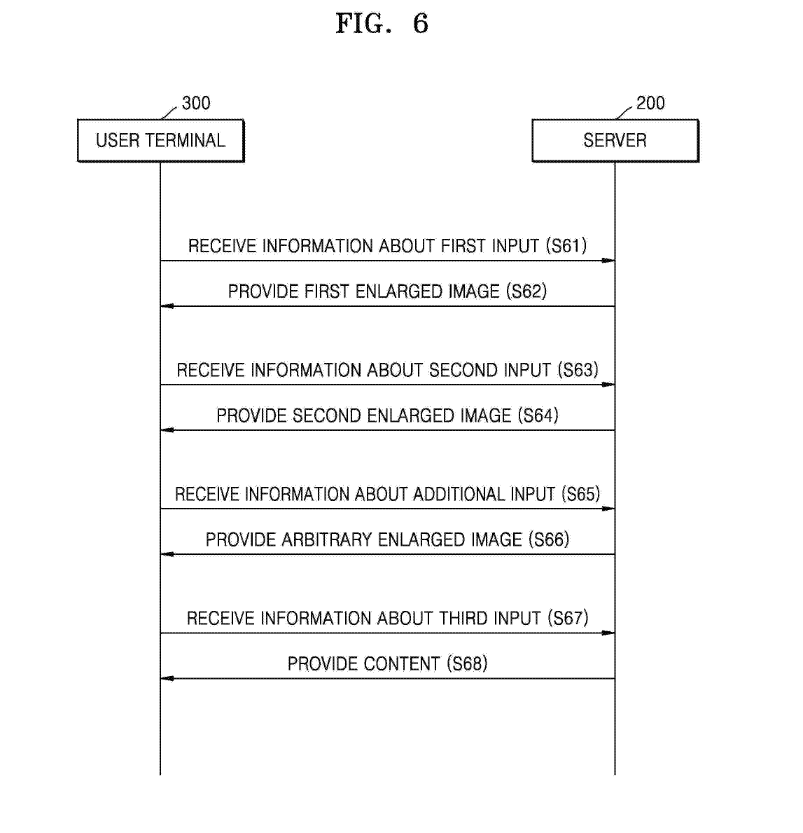

A content providing method performed by a user terminal according to at least one example embodiment will now be described with reference to FIGS. 1 through 3. Also, a content providing apparatus according to at least one example embodiment will be described with reference to FIGS. 4 through 6.

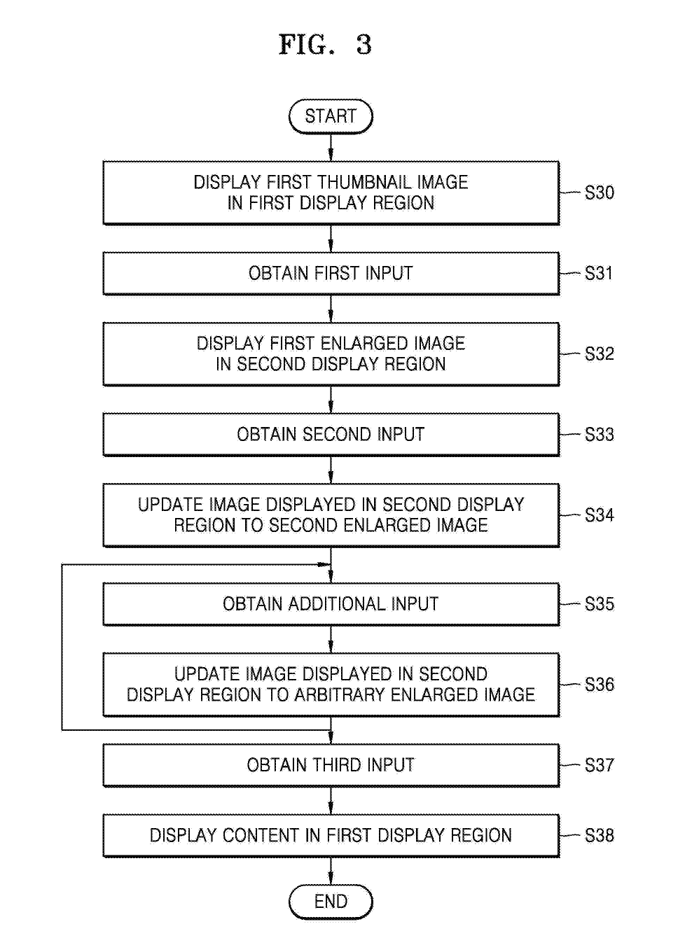

FIGS. 1 and 2 are diagrams of a user terminal 100 according to at least one example embodiment.

The user terminal 100 may be a personal computer (PC) or a portable terminal. In FIG. 1, the user terminal 100 is a portable terminal and is shown as a smart phone, but the user terminal 100 is not limited thereto and may be embodied by other portable electronic devices including, for example, a laptop or tablet.

Referring to FIG. 2, the user terminal 100 according to at least one example embodiment may include a display 110, a first controller 120, and a first data storage unit 130.

The display 110 according to at least one example embodiment may be a display apparatus displaying a figure, a letter, or a combination thereof according to an electric signal generated by the first controller 120. For example, the display 110 may include one or more of a cathode ray tube (CRT), a liquid crystal display (LCD), a plasma display panel (PDP), and an organic light-emitting diode (OLED), but is not limited thereto.

The display 110 may further include an input unit for obtaining an input of a user. For example, the display 110 may further include a digitizer that reads touch coordinates of the user and converts the touch coordinates to an electric signal so as to obtain an input of the user according to a screen displayed on the display 110. Accordingly, the display 110 may be a touch screen including a touch panel. Here, the touch panel may not only convert touch coordinates to an electric signal, but may also read and convert touch pressure to an electric signal.

Here, the input unit may be provided separately from the display 110. For example, the input unit may be any one of a keyword, a mouse, a track ball, a microphone, and a button, which is provided separately from the display 110.

Hereinafter, the display 110 is a touch screen including an input unit capable of determining a touch of the user and touch pressure, but is not limited thereto.

When the display 110 obtained a first input of the user with respect to a first thumbnail image displayed on the display 110, the first controller 120 may display, on the display 110, a first enlarged image corresponding to the first thumbnail image according to the first input obtained by the display 110.

As described above, since the display 110 may be a touch screen, the first input, and second, third, and additional inputs, which will be described later, may be inputs of the user on the touch screen.

Also, the first through third inputs and the additional input may each be any one of a simple touch input, an input including a plurality of different touch pressures, an input moving in one direction at at least a desired or, alternatively, pre-set speed, an input in which a plurality of inputs are repeated within a desired or, alternatively, pre-set time, and an input continued for a desired or, alternatively, pre-set period of time.

In the current embodiment, a thumbnail image, such as a first or second thumbnail image, may be an image of a part of one of a picture, a video, text, and a document. For example, a thumbnail image of content such as a picture may be an image that has been down-scaled to a smaller size or lower resolution compared to the picture. Also, a thumbnail image of content such as a video may be an image of one scene of the video. A thumbnail image of content including writing, such as text or a document, may be an image including a part of letters forming the text or the document. Here, when content is a document, an extension of the document may be further included in a thumbnail image. Hereinafter, the term ‘thumbnail image’ may indicate any thumbnail image, such as a first or second thumbnail image.

Meanwhile, the term ‘image’ may indicate something that is displayed on a screen, and may not only indicate a simple image, but also indicate content in a form of text. Thus, the ‘image including some letters forming the text or the document’ may indicate that some forming content are being displayed.

In the current embodiment, an enlarged image, such as a first or second enlarged image, may be an image obtained by enlarging a thumbnail image corresponding to the enlarged image. Accordingly, an enlarged image of content such as a picture or a video may be an enlarged image of a thumbnail image of the content. Also, an enlarged image of content such as text or a document may be a part of letters forming the text or the document, and may be an image in which only letters displayed in a thumbnail image are displayed or an image in which letters displayed in a thumbnail and additional letters are displayed.

Here, an enlarged image may be an image of content itself. For example, an enlarged image of content such as a picture may not be an enlarged image of a thumbnail image, but may be the content itself, i.e., the picture. Also, an enlarged image of content such as a video may not be an image of one scene of the video, but may be an image that changes as the content is reproduced, i.e., as the video is reproduced.

Hereinafter, the term ‘enlarged image’ may include any enlarged image, such as a first or second enlarged image.

In the present specification, content may be an intangible object obtained by producing a letter, a mark, voice, sound, an image and/or a video by using a digital method. Accordingly, content may be an object stored in a computer-readable file format. Examples of content herein include a picture, a video, text, and a document, but are not limited thereto.

Meanwhile, when the first input obtained by the display 110 corresponds to a certain input, the first controller 120 may directly display, instead of the first enlarged image corresponding to the first thumbnail image, content corresponding to the first thumbnail image on the display 110. Here, the certain input may be an input for immediately checking the content corresponding to the first thumbnail image, such as a simple touch.

When the display 110 obtained a second input of the user with respect to a second thumbnail image, wherein the second input is a continuative input of the first input with respect to the first thumbnail image, the first controller 120 may update the first enlarged image displayed on the display 110 to a second enlarged image according to the second input. Here, the second enlarged image may be an image corresponding to the second thumbnail image.

Herein, a ‘continuative input’ may indicate that two or more inputs are connected via a drag. Here, a drag may denote an input moving from one point to another point without releasing the input.

For example, ‘a second input continuative to a first input’ may denote ‘an input including a plurality of different touch pressures’ that is the first input and ‘an input continued for at least a certain period of time’ that is the second input.

Herein, ‘an input of a user with respect to a thumbnail image’ may denote an input with respect to a location where the thumbnail image is displayed or recognized to be displayed in the display 110. Accordingly, an input with respect to a thumbnail image may be performed not only when the thumbnail image is displayed on the display 110, but also even when the thumbnail image is hidden by a second display region that will be described later.

The first controller 120 may display the first and second thumbnail images in a first display region and the first and second enlarged images in a second display region.

Herein, the first and second display regions may be separated regions in one display 110, each displaying an image or content, or may be display regions of one or more displays 110.

For example, when the user terminal 100 according to at least one example embodiment includes a plurality of the displays 110, the first controller 120 may display a thumbnail image in the first display region, i.e., a display region of a first display (not shown), and display an enlarged image in the second display region, i.e., a display region of a second display (not shown).

Meanwhile, when the user terminal 100 according to at least one example embodiment includes one display 110, the first controller 120 may display a thumbnail image in the first display region in the display 110, and display an enlarged image in the second display region in the display 110. In this case, the first controller 120 may display content of the second display region to overlap content of the first display region. Here, overlapping may mean that the content of the second display region is displayed on the display 110 within a range in which the first and second display regions overlap. Alternatively, the first controller 120 may overlap and display a first layer where the first display region is displayed and a second layer where the second display region is displayed, and at this time, the first controller 120 assumes that the second layer is on top, i.e., assigns priority to the second layer such that the content of the second display region is displayed on the display 110 within the range in which the first and second display regions overlap.

Hereinafter, for convenience of description, it is described that the second display region is displayed on the display 110 by overlapping the first display region, wherein the second display region is smaller than the first display region and the first display region is an entire region of the display 110, but at least some examples embodiments are not limited thereto.

Similarly, when the display 110 obtains an additional input of the user with respect to an arbitrary thumbnail image different from the second thumbnail image, wherein the additional input is continuative to the second input with respect to the second thumbnail image, the first controller 120 may update the second enlarged image displayed on the display 110 to an enlarged image corresponding to the arbitrary thumbnail image, according to the additional input. Accordingly, the first controller 120 may update an enlarged image displayed on the display 110 according to a changed input as long as a plurality of continuative inputs (i.e., inputs connected via a drag) are input to the display 110. Here, the term ‘continuative inputs’ are at least two inputs connected via a drag as described above.

Meanwhile, the second input may be performed in the second display region overlapping the first display region as described above. In this case, it may be determined that, through the second input, a thumbnail image at a location corresponding to the second input in the first display region is selected. Accordingly, when a continuative input of the user on the second display region overlapping the first display region is performed, an enlarged image may be updated based on a thumbnail image in the first display region, which is at a location corresponding to the continuative input.

When the display 110 obtains a third input of the user with respect to the second thumbnail image or the arbitrary thumbnail image, wherein the third input is continuative to the second input or the additional input described above, the first controller 120 may display, in the first display region of the display 110, at least a part of the second content corresponding to the second thumbnail image or arbitrary content corresponding to the arbitrary thumbnail image, according to the third input. Here, the first controller 120 may set the second display region to be blank so that there is no first display region covered by the second display region. According to such processes, the user may quickly check a plurality of pieces of content stored in the user terminal 100 through a preview.

For example, when the first and third inputs are each an input including a plurality of different touch pressures, and the second input is an input continued for a certain period of time, the user may preform the input including a plurality of different touch pressures with respect to a thumbnail image displayed in the first display region such that an enlarged image of the thumbnail image is displayed, and may perform the input with respect to another thumbnail image through a drag input such that the enlarged image is updated. Also, the user may perform the input including a plurality of different touch pressures with respect to a thumbnail image of content to be selected during such a dragging process such that the content is displayed on the display 110.

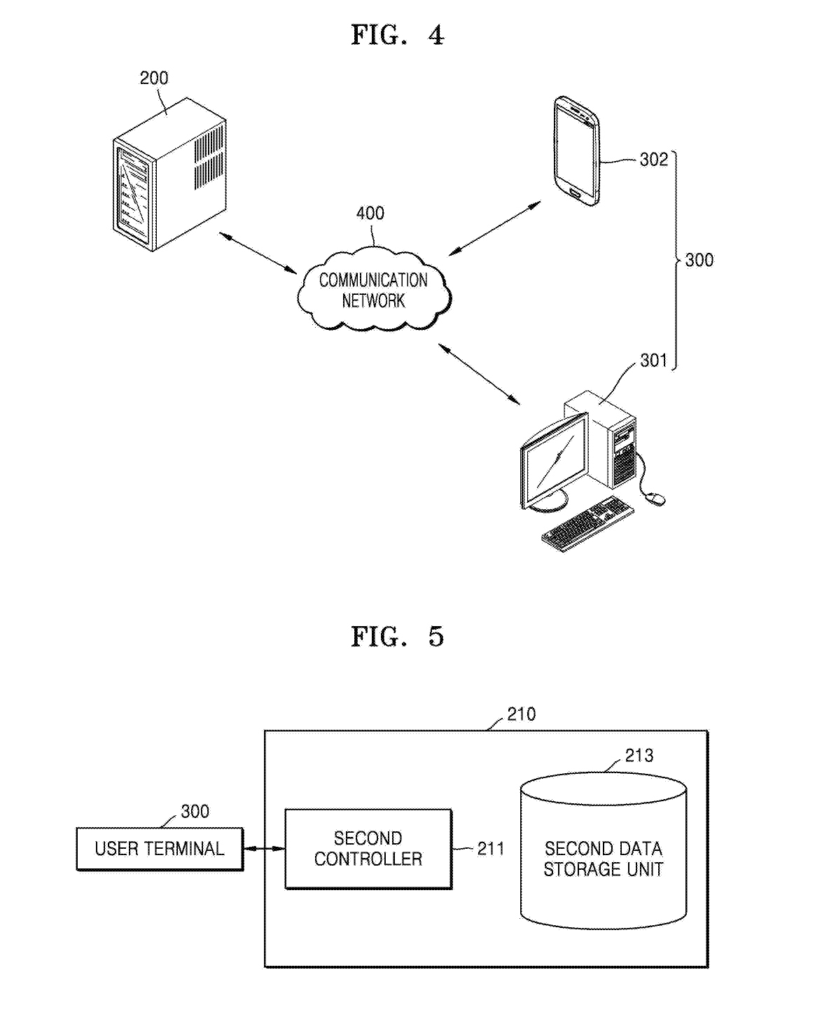

FIG. 3 is a flowchart of a content providing method performed by the user terminal 100, according to at least one example embodiment. Hereinafter, details overlapping those described above with reference to FIGS. 1 and 2 are not provided again.

The first controller 120 may display the first thumbnail image in the first display region of the display 110, in operation S30. In other words, when an application according to at least one example embodiment is executed by the user, the first thumbnail image may be displayed in the first display region of the display 110 of the user terminal 100.

When the display 110 obtains the first input of the user with respect to the first thumbnail image displayed in the first display region of the display 110, in operation S31, the first controller 120 may display, in the second display region of the display 110, the first enlarged image corresponding to the first thumbnail image according to the first input obtained by the display 110, in operation S32.

As described above, the display 110 may be a touch screen, and thus the first input may be an input performed by the user on the touch screen.

Also, the first through third input, and the additional input may each be any one of a simple touch input, an input including a plurality of different touch pressures, an input moving in one direction at at least a desired or, alternatively, pre-set speed, an input in which a plurality of inputs are repeated within a desired or, alternatively, pre-set time, and an input continued for a desired or, alternatively, pre-set period of time.

When the display 110 obtains the second input of the user with respect to the second thumbnail image, wherein the second input is a continuative input of the first input with respect to the first thumbnail image, in operation S33, the first controller 120 may update the first enlarged image displayed in the second display region of the display 110 to the second enlarged image, according to the second input, in operation S34. Here, the second enlarged image may be an image corresponding to the second thumbnail image.

Herein, a ‘continuative input’ may mean that two or more inputs are connected via a drag. Here, a drag may denote an input moving from one point to another point without releasing the input.

For example, ‘a second input continuative to a first input’ may denote ‘an input including a plurality of different touch pressures’ that is the first input and ‘an input continued for at least a certain period of time’ that is the second input.

Herein, ‘an input of a user with respect to a thumbnail image’ may denote an input with respect to a location where the thumbnail image is displayed or recognized to be displayed in the display 110. Accordingly, an input with respect to a thumbnail image may be performed not only when the thumbnail image is displayed on the display 110, but also even when the thumbnail image is hidden by a second display region described later.

When the display 110 obtains the additional input of the user with respect to the arbitrary thumbnail image in operation S35, wherein the additional input is continuative to the second input with respect to the second thumbnail image, the first controller 120 may update the second enlarged image displayed in the second display region of the display 110 to the arbitrary enlarged image according to the additional input, in operation S36. Here, the arbitrary enlarged image may be an image corresponding to the arbitrary thumbnail image.

When the display 110 repeatedly obtains the additional input described above, the first controller 120 may update an enlarged image displayed in the second display region of the display 110 according to the repeatedly obtained additional inputs. Accordingly, the first controller 120 may update an enlarged image displayed on the display 110 according to a changed input as long as a plurality of continuative inputs (i.e., inputs connected via a drag) are input to the display 110.

When the display 110 obtains the third input of the user with respect to the second thumbnail image or the arbitrary thumbnail image in operation S37, wherein the third input is a continuative input of the second input or the additional input described above, the first controller 120 may display, in the first display region of the display 110, at least a part of the second content or the arbitrary content according to the third input, in operation S37. Here, the first controller 120 may set the second display region to be blank so that there is no first display region covered by the second display region. Meanwhile, the second content may be to content corresponding to the second thumbnail image or the second enlarged image, and the arbitrary content may be content corresponding to the arbitrary thumbnail image or the arbitrary enlarged image.

Meanwhile, the first, second, and arbitrary thumbnail images, the first, second, and arbitrary enlarged images, and the first, second, and arbitrary content may be pre-stored in the first data storage unit 130.

Accordingly, the user may be able to quickly find content by searching content corresponding to each thumbnail image. In other words, according to a general technology, a user has to perform, in countless numbers, processes of performing an input of selecting one of thumbnail images, determining whether content corresponding to the selected thumbnail image and displayed on a display is content to be found, and when it is determined that the displayed content is not content to be found, returning to a screen displaying the thumbnail images to perform an input of selecting another thumbnail image until the content to be found is found.

However, according to the present disclosure, a time searching for content to be found by the user may be reduced because information more detailed than a thumbnail image is quickly previewed without having to switch to a screen displaying the content to be found according to a series of continuative inputs.

Also, the user may be able to conveniently check detailed information about content by using an input distinguished from an input for selecting the content corresponding to a thumbnail image, for example, by using an input including a plurality of different touch pressures, and to conveniently find content, without any complicated manipulation, by quickly checking a plurality of pieces of content by using continuous inputs.

Hereinafter, a content providing apparatus according to at least one example embodiment will be described with reference to FIGS. 4 through 6. In the above embodiments, a series of processes of providing content by the user terminal 100 has been described. However, in the current embodiment, processes of providing content to a user terminal from a server connected to the user terminal through a network will be described.

FIG. 4 is a diagram of a content providing system according to at least one example embodiment.

Referring to FIG. 4, the content providing system according to at least one example embodiment includes a server 200, a user terminal 300, and a communication network 400 connecting the server 200 and the user terminal 300.

The content providing system according to at least one example embodiment may provide, to the user terminal 300, a content providing program or a content providing website. The content providing system according to at least one example embodiment may receive input information of a user from the user terminal 300, and transmit content to the user terminal 300 according to the received input information.

Referring to FIG. 4, the user terminal 300 is a communication terminal capable of using a web service in a wired or wireless communication environment. The user terminal 300 may be a PC 301 or a portable terminal 302. In FIG. 4, the portable terminal 302 is shown as a smart phone, but at least some example embodiments of the inventive concepts are not limited thereto, and the portable terminal 302 may be any terminal including an application capable of web browsing as described above.

The user terminal 300 may include a display unit functioning as a display unit and an input unit, a controller, and a communication unit like the user terminal 100 described above.

The communication network 400 connects the server 200 and the user terminal 300. For example, the communication network 400 provides an access path after accessing the server 200 and the user terminal 300 such that packet data is exchanged. Examples of the communication network 400 include wired networks, such as a local area network (LAN), a wide area network (WAN), a metropolitan area network (MAN), and an integrated service digital network (ISDN), and wireless networks, such as a wireless LAN, CDMA, Bluetooth, and satellite communication, but are not limited thereto.

The server 200 provides, to the user terminal 300, a webpage providing a content providing program and/or a content providing service. For example, the server 200 may receive information about an input from the user terminal 300 and provide an image and/or content according to the received information, through the webpage providing the content providing program and/or the content providing service.

Although not illustrated, the server 200 according to at least one example embodiment may include a memory, an input/output unit, a communication unit, etc. The memory may temporarily or permanently store data, an instruction, a program, a program code, or a combination thereof, which is processed by the server 200. Examples of the memory may include magnetic storage media and flash storage media, but are not limited thereto. The communication unit may be an apparatus including hardware and software required to transmit and receive a signal, such as a control signal or a data signal, to and from another network apparatus through a wired or wireless connection. The controller may include any type of apparatus capable of processing data, such as a processor. Herein, a ‘processor’ may be a hardware-embedded data processing apparatus having a physically structured circuit to perform functions expressed in codes or instructions included in a program. Examples of the hardware-embedded data processing apparatus include a microprocessor, a CPU, a processor core, a multiprocessor, an application-specific integrated circuit (ASIC), and a FPGA, but are not limited thereto.

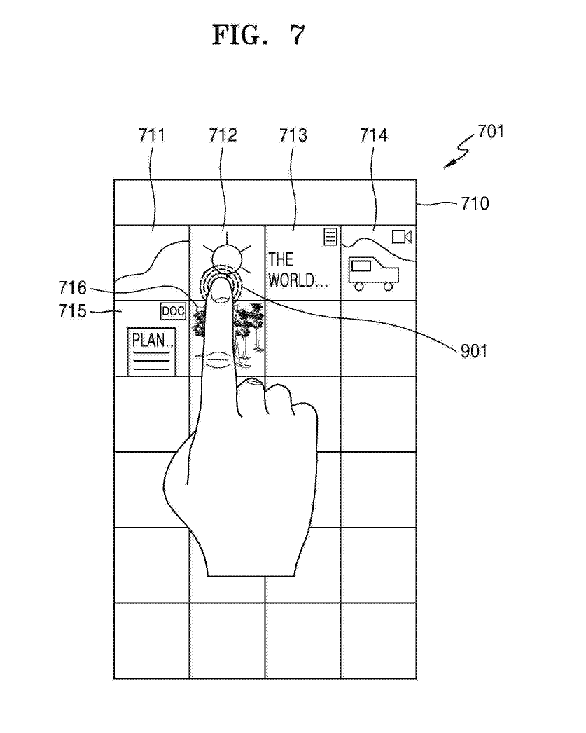

FIG. 5 is a block diagram of a content providing apparatus 210 included in the server 200 of FIG. 4.

The content providing apparatus 210 according to at least one example embodiment may correspond to at least one processor or may include at least one processor. Accordingly, the content providing apparatus 210 may be driven by being included in a hardware apparatus, such as a microprocessor or a general-purpose computer system. The content providing apparatus 210 may be included in the server 200, but at least some example embodiments of the inventive concepts are not limited thereto, and may be included in the user terminal 300 based on a design of the content providing apparatus 210.

The content providing apparatus 210 according to at least one example embodiment may include a second controller 211 and a second data storage unit 213.

The second controller 211 according to at least one example embodiment may receive information about a first input that is an input of the user with respect to a first thumbnail image, from the user terminal 300. The user terminal 300 may transmit, as the first input, an input with respect to the first thumbnail image displayed on a display of the user terminal 300 to the second controller 211.

In the current embodiment, a thumbnail image, such as a first or second thumbnail image, is an image of a part of any one of pieces of content, such as a picture, a video, text, and a document, and may be an image including a desirably low amount information for representing the content or, alternatively, minimum information for representing the content. For example, the server 200 may transmit thumbnail images of the pieces of content to the user terminal 300, as examples of providable content. Here, the user may select one of the thumbnail images displayed on the display of the user terminal 300 to receive an enlarged image and/or content corresponding to the selected thumbnail image. As such, the server 200 may provide a thumbnail image including a desirably low amount information about the content or, alternatively, minimum information about content to the user terminal 300 to briefly notify the user about content stored in the server 200 without having to completely transmit the content. The user may select a thumbnail image in the user terminal 300 to selectively receive an enlarged image and/or content corresponding to the thumbnail image.

In the current embodiment, an enlarged image, such as a first or second enlarged image, may be an image including more detailed information about content than a thumbnail image corresponding to the enlarged image. Accordingly, an enlarged image of content such as a picture may be an image down-sampled to a resolution higher than a thumbnail image, and an enlarged image of content such as a video may be a scene of the video, which is captured in a higher resolution or an image changing as the video is reproduced.

Here, an enlarged image may be an image of content itself. For example, an enlarged image of content such as a picture may be the content itself, i.e., the picture, instead of an enlarged image of a thumbnail image. Also, an enlarged image of content such as a video may be an image changing as the content, i.e., the video, is reproduced, instead of an image of a scene of the video.

As described above, the display of the user terminal 300 may be a touch screen, and thus the first input, and second, third, and additional inputs described below may each be an input performed by the user on the touch screen.

Also, the first through third inputs and the additional input may each be any one of a simple touch input, an input including a plurality of different touch pressures, an input moving in one direction at at least a desired or, alternatively, pre-set speed, an input in which a plurality of inputs are repeated within a desired or, alternatively, pre-set time, and an input continued for a desired or, alternatively, pre-set period of time.

Herein, ‘an input of a user with respect to a thumbnail image’ may denote an input with respect to a location where the thumbnail image is displayed or recognized to be displayed in the display of the user terminal 300. Accordingly, an input with respect to a thumbnail image may be performed not only when the thumbnail image is displayed on the display of the user terminal 300, but also even when the thumbnail image is hidden by a second display region that will be described later.

The second controller 211 may provide a first enlarged image corresponding to the first thumbnail image to the user terminal 300 by referring to the received information about the first input.

As described above, an enlarged image may be an image including more detailed information about content compared to a thumbnail image. When an enlarged image includes more information about content, the number of packets used to provide the enlarged image from the server 200 to the user terminal 300 and a transmission time of the packets may increase, and thus, an amount of information included in the enlarged image may be determined in consideration of an operation environment of a content providing system and an overall objective of a user. For example, when a quick operation is required, an enlarged image may include an amount of information similar to a thumbnail image. However, when a high quality image needs to be provided instead of a quick operation, an enlarged image may include an amount of information similar to original content.

As described above, the second controller 211 may immediately provide, to the user terminal 300, content corresponding to the first thumbnail image instead of providing the first enlarged image corresponding to the first thumbnail image, when the first input corresponds to a certain input, based on the received information about the first input. Here, the certain input may be an input for immediately checking the content corresponding to the first thumbnail image, such as a simple touch.

The second controller 211 may receive, from the user terminal 300, information about a second input of the user with respect to a second thumbnail image displayed on the display of the user terminal 300, wherein the second input is continuative to the first input.

As described above, a ‘continuative input’ may indicate that two or more inputs are connected via a drag. Here, a drag may denote an input moving from one point to another point without releasing the input.

For example, ‘a second input continuative to a first input’ may denote ‘an input including a plurality of different touch pressures’ that is the first input and ‘an input continued for at least a certain period of time’ that is the second input.

The second controller 211 may provide, to the user terminal 300, a second enlarged image corresponding to the second thumbnail image by referring to the information about the second input received from the user terminal 300.

The second controller 211 may receive information about an additional input of the user with respect to an arbitrary thumbnail image displayed on the display of the user terminal 300, wherein the additional input is continuative to the second input. The second controller 211 may provide, to the user terminal 300, an arbitrary enlarged image corresponding to the arbitrary thumbnail image by referring to the information about the additional input. Meanwhile, the content providing apparatus 210 according to the current embodiment may repeatedly receive the information about the additional input and provide the arbitrary enlarged image. Accordingly, the content providing apparatus 210 may provide, to the user terminal 300, an arbitrary enlarged image according to a plurality of inputs as long as the second controller 211 receives a plurality of continuative inputs, which are connected via a drag.

The second controller 211 may receive information about a third input of the user with respect to the second thumbnail image or the arbitrary thumbnail image displayed on the display of the user terminal 300, wherein the third input is continuative to the second input or the additional input, and provide, to the user terminal 300, second content or arbitrary content by referring to the information about the third input. Here, the second content may be content corresponding to the second thumbnail image or the second enlarged image, and the arbitrary content may be content corresponding to the arbitrary thumbnail image or the arbitrary enlarged image.

The user may check content through the user terminal 300 when the second controller 211 provides the content.

Meanwhile, an enlarged image and content provided from the server 200 to the user terminal 300 may be pre-stored in the second storage unit 213. Here, a thumbnail image provided when the server 200 and the user terminal 300 are initially connected to each other may also be stored in the second data storage unit 213.

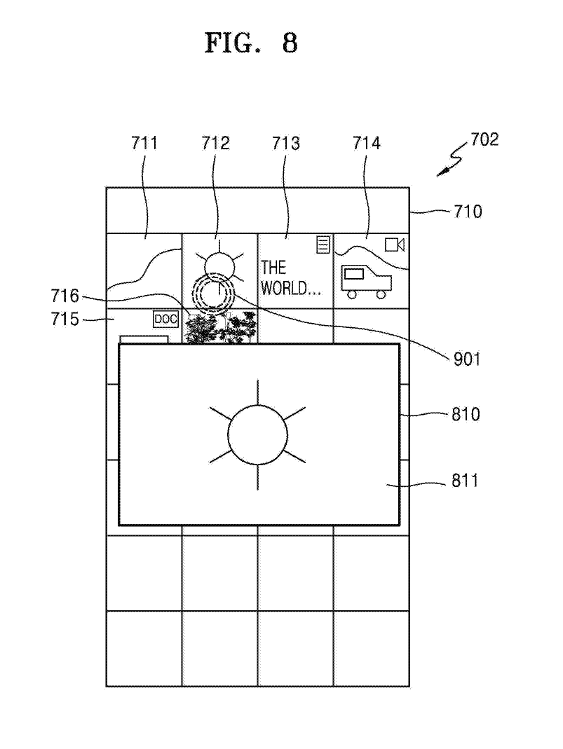

FIG. 6 is a flowchart of an information processing method performed between the server 200 and the user terminal 300. Here, since the server 200 in FIG. 6 may include the content providing apparatus 210 of FIG. 5, details about the content providing apparatus 210 described above with reference to FIG. 5 may also be applied to FIG. 6 even if omitted below.

Referring to FIG. 6, the server 200 according to at least one example embodiment may receive the information about the first input that is an input of the user with respect to the first thumbnail image, from the user terminal 300, in operation S61.

The second controller 211 may provide, to the user terminal 300, the first enlarged image corresponding to the first thumbnail image by referring to the received information about the first input, in operation S62.

The second controller 211 may receive, from the user terminal 300, the information about the second input of the user with respect to the second thumbnail image displayed on the display of the user terminal 300, wherein the second input is continuative to the first input, in operation S63.

The second controller 211 may provide, to the user terminal 300, the second enlarged image corresponding to the second thumbnail image by referring to the information about the second input received from the user terminal 300, in operation S64.

The second controller 211 may receive the information about the additional input of the user with respect to the arbitrary thumbnail image displayed on the display of the user terminal 300, wherein the additional input is continuative to the second input, in operation S65.

The second controller 211 may provide, to the user terminal 300, the arbitrary enlarged image corresponding to the arbitrary thumbnail image by referring to the information about the additional input, in operation S66. Meanwhile, the content providing apparatus 210 according to the current embodiment may repeatedly receive information about an additional input and provide an arbitrary enlarged image. In other words, the content providing apparatus 210 according to the current embodiment may repeatedly perform operations S65 and S66 as long as an input of the user is continuative.

The second controller 211 may receive the information about the third input of the user with respect to the second thumbnail image or the arbitrary thumbnail image displayed on the display of the user terminal 300, wherein the third input is continuative to the second input or the additional input, in operation S67, and provide the second content or the arbitrary content to the user terminal 300 by referring to the information about the third input, in operation S68. Here, the second content may be content corresponding to the second thumbnail image or the second enlarged image, and the arbitrary content may be content corresponding to the arbitrary thumbnail image or the arbitrary enlarged image.

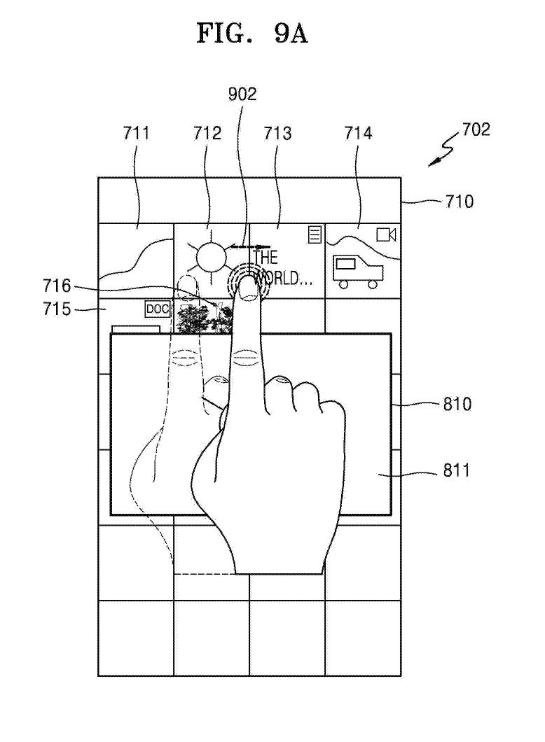

FIGS. 7 through 10 illustrate screens displayed on the user terminal 100 or 300, according to at least one example embodiment.

FIG. 7 illustrates a screen 701 for obtaining an input of a user with respect to a thumbnail image displayed on a display of the user terminal 100 or 300, according to at least one example embodiment.

Referring to FIG. 7, the screen 701 may include a first display region 710 displaying thumbnail images 711 through 714.

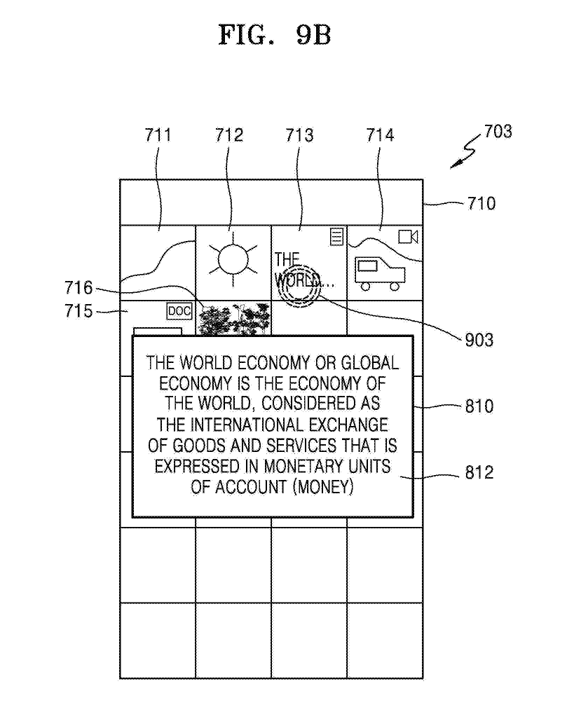

FIG. 7 illustrates processes of a user performing a first input 901 with respect to the first thumbnail image 712. Here, the first input 901 may be an input including a plurality of different touch pressures. Here, the user may perform the input including a plurality of different touch pressures with respect to the first thumbnail image 712 such that a first enlarged image is displayed. Alternatively, the first input 901 may be an input continued for at least a desired or, alternatively, pre-set period of time. In this case, the user may perform the input continued for the desired or, alternatively, pre-set period of time with respect to the first thumbnail image 712 such that the first enlarged image is displayed. Details will be described below with reference to FIG. 8.

FIG. 8 illustrates a screen 702 in which a first enlarged image 811 is displayed on the display of the user terminal 100 or 300 according to a first input of a user.

Referring to FIG. 8, the screen 702 may include the first display region 710 displaying the thumbnail images 711 through 715 and a second display region 810 displaying a first enlarged image 811. Here, the first enlarged image 811 displayed in the second display region 810 may be displayed on the display within a range in which the first and second display regions overlap. The user may search for desired content by checking an enlarged image updated on the second display region 810 while performing second and third inputs as described below.

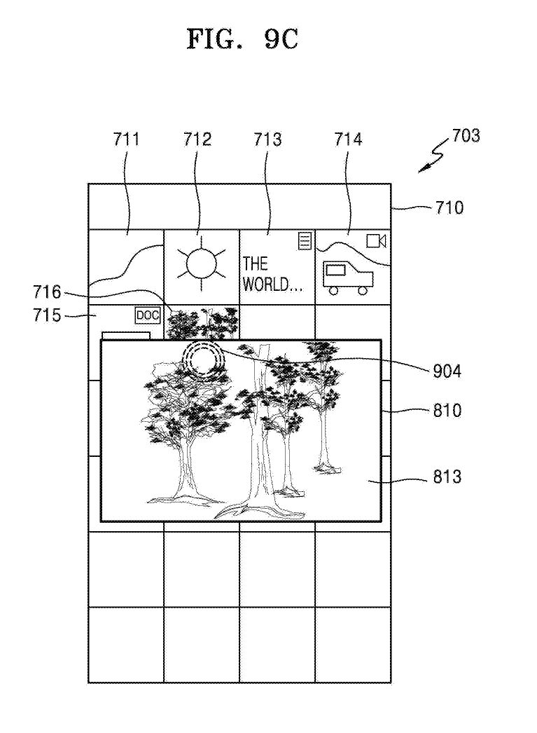

FIGS. 9A through 9C illustrate a screen 703 for describing processes of obtaining a second input 903 continuative to the first input 901.

Referring to FIGS. 9A through 9C, the user may perform a drag input 902 without releasing the first input 901 such that the user terminal 100 or 300 obtains the second input 903 continuative to the first input 901.

In FIGS. 9A and 9B, the second input 903 with respect to a second thumbnail image 713 is obtained, wherein the second input 903 is continuative to the first input 901 with respect to the first thumbnail image 712, and content corresponding to the second thumbnail image 713 is text.

Referring to FIG. 9B, an enlarged image displayed on the second display region 810 is updated from the first enlarged image 811 to a second enlarged image 812 according to the second input 903.

In FIG. 9C, a second input 904 with respect to a third thumbnail image 716 is obtained, wherein the second input 904 is continuative to the first input 901 with respect to the first thumbnail image 712 and content corresponding to the third thumbnail image 716 is an image.

Referring to FIG. 9C, as described above, the second input 904 with respect to the third thumbnail image 716 may be performed in the second display region 810 overlapping the first display region 710. In this case, it may be determined that the second input 904 selected the third thumbnail image 716 at a location corresponding to the second input 904 in the first display region 710. Accordingly, an enlarged image displayed in the second display region 810 may be updated to a third enlarged image 813 according to the second input 904.

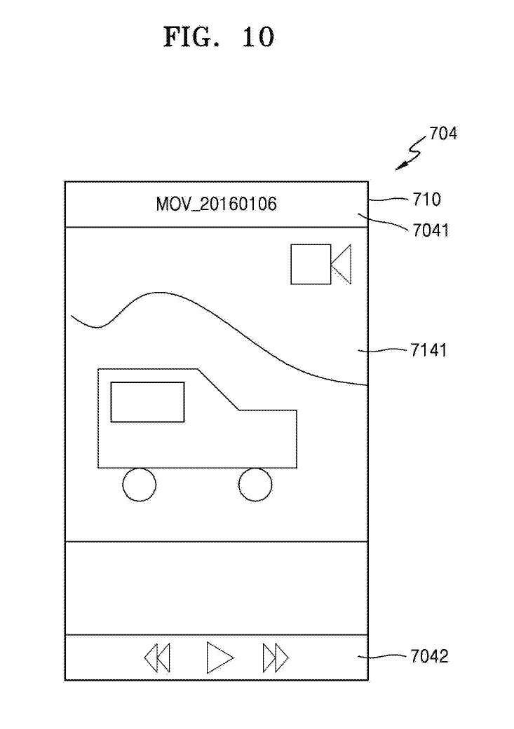

FIG. 10 illustrates a screen 704 in which content corresponding to a third thumbnail image 714 is displayed in the first display region 710.

Referring to FIG. 10, the screen 704 may include the first display region 710 displaying content. Here, the first display region 710 may include an information display window 7041 displaying information about the content and a control window 7042 for controlling displaying of the content. In addition, the first display region 710 may include a region 7141 displaying the content.

In FIG. 10, the content corresponding to the third thumbnail image 714 is a video, wherein the information display window 7041 displays a file name of the video, the control window 7042 displays buttons for controlling reproducing of the video, and the region 7141 displays the video.

A content providing method, a content providing apparatus, and a content providing program according to one or more embodiments may enable a user to quickly find content, without having to individually check each of a plurality of pieces of content, by displaying an enlarged image of content corresponding to a thumbnail image over thumbnail images when the user provides a certain input with respect to the thumbnail image.

Also, a content providing method, a content providing apparatus, and a content providing program according to one or more embodiments may enable a user to conveniently check detailed information about content by using an input distinguished from an input for selecting the content corresponding to a thumbnail image, for example, by using an input including a plurality of different touch pressures, and to conveniently find content, without any complicated manipulation, by quickly checking a plurality of pieces of content by using continuous inputs.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be modified in various ways.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

What is claimed is:

1. A non-transitory computer readable medium storing computer-executable instructions that, when executed by one or more processors, cause the one or more processors to perform operations including:
obtaining a first input with respect to a first thumbnail image displayed on a display;
displaying, on the display, a first enlarged image corresponding to the first thumbnail image according to the first input;
obtaining a second input with respect to a second thumbnail image, wherein the second input is continuative to the first input; and
updating the first enlarged image displayed on the display to a second enlarged image corresponding to the second thumbnail image.

2. The non-transitory computer-readable medium of claim 1, wherein,
the operations further include,
displaying the first thumbnail image and the second thumbnail image in a first display region, and
determining the second input based on the first display region,
the displaying of the first enlarged image includes displaying the first enlarged image in a second display region, and
the updating of the first enlarged image includes displaying the second enlarged image in the second display region.

3. The non-transitory computer-readable medium of claim 2, wherein the operations include,
displaying the second display region to overlap the first display region, and
displaying the first enlarged image or the second enlarged image, which is displayed in the second display region, in a region where the first and second display regions overlap.

4. The non-transitory computer-readable medium of claim 2, wherein the operations further include,
obtaining a third input with respect to the second thumbnail image, wherein the third input is continuative to the second input; and
displaying, in the first display region, at least a part of second content according to the third input,
wherein the second content corresponds to content corresponding to the second thumbnail image or the second enlarged image.

5. The non-transitory computer-readable medium of claim 2, wherein the operations further include,
displaying a third thumbnail image in the first display region,
obtaining a fourth input with respect to the third thumbnail image, wherein the fourth input is continuative to the second input;
updating the second enlarged image displayed in the second display region to a third enlarged image corresponding to the third thumbnail image;
obtaining a third input with respect to the third thumbnail image, wherein the third input is continuative to the fourth input; and
displaying, in the first display region, at least a part of third content according to the third input,
wherein the third content corresponds to content corresponding to the third thumbnail image or the third enlarged image, and
the obtaining of the fourth input and the updating to the third enlarged image is repeatedly performed.

6. The non-transitory computer-readable medium of claim 4, wherein the operations further include setting the second display region to be a blank.

7. The non-transitory computer-readable medium of claim 6, wherein the second content is one of a picture, a video, text, and a document.

8. The non-transitory computer-readable medium of claim 7, wherein the first thumbnail image and the second thumbnail image are each one of a thumbnail image of the picture, a scene in the video, an image including a part of the text, and an image of a part of the document.

9. The non-transitory computer-readable medium of claim 4, wherein the third input is an input on the display displaying the first display region and the second display region, and is one of an input including a plurality of different touch pressures, an input moving in one direction at at least a first speed, an input in which a plurality of inputs are repeated within a first time period, and an input continued for a first period of time.

10. The non-transitory computer-readable medium of claim 2, wherein the first input is an input on the display displaying the first display region and the second display region, and is one of an input including a plurality of different touch pressures and an input continued for a first period of time.

11. A content providing method comprising:
obtaining a first input with respect to a first thumbnail image displayed on a display;
displaying, on the display, a first enlarged image corresponding to the first thumbnail image according to the first input;
obtaining a second input with respect to a second thumbnail image, wherein the second input is continuative to the first input; and
updating the first enlarged image displayed on the display to a second enlarged image corresponding to the second thumbnail image.

12. The content providing method of claim 11, further comprising:
displaying the first thumbnail image and the second thumbnail image in a first display region; and
determining the second input based on the first display region,
the displaying of the first enlarged image including displaying the first enlarged image in a second display region, and
the updating of the first enlarged image including displaying the second enlarged image in the second display region.

13. The content providing method of claim 1, further comprising:
obtaining a third input with respect to the second thumbnail image, wherein the third input is continuative to the second input; and
displaying, in the first display region, at least a part of second content according to the third input,
wherein the second content corresponds to content corresponding to the second thumbnail image or the second enlarged image.

14. The content providing method of claim 12, further comprising:
displaying a third thumbnail image in the first display region;
obtaining a fourth input with respect to the third thumbnail image, wherein the fourth input is continuative to the second input;
updating the second enlarged image displayed in the second display region to a third enlarged image corresponding to the third thumbnail image;
obtaining a third input with respect to the third thumbnail image, wherein the third input is continuative to the fourth input; and
displaying, in the first display region, at least a part of third content according to the third input,
wherein the third content corresponds to content corresponding to the third thumbnail image or the third enlarged image, and
the obtaining of the fourth input and the updating to the third enlarged image is repeatedly performed.

15. The content providing method of claim 14, further comprising: setting the second display region to be a blank.

16. A content providing apparatus comprising:
a controller configured to,
receive, from a user terminal, information about a first input with respect to a first thumbnail image displayed on a display of the user terminal,
provide, to the user terminal, a first enlarged image corresponding to the first thumbnail image by referring to the information about the first input,
receive information about a second input with respect to a second thumbnail image displayed on the display, wherein the second input is continuative to the first input, and
provide, to the user terminal, a second enlarged image corresponding to the second thumbnail image by referring to the information about the second input.

17. The content providing apparatus of claim 16, wherein the controller is further configured to,
receive information about a third input of the user with respect to the second thumbnail image displayed on the display, wherein the third input is continuative to the second input; and
provide, to the user terminal, second content by referring to the information about the third input,
wherein the second content is content corresponding to the second thumbnail image or the second enlarged image.

18. The content providing apparatus of claim 16, wherein the controller is further configured to,
receive information about a fourth input with respect to a third thumbnail image displayed on the display, wherein the fourth input is continuative to the second input;
provide, to the user terminal a third enlarged image corresponding to the third thumbnail image by referring to the information about the fourth input;
receive information about a third input with respect to the third thumbnail image displayed on the display, wherein the third input is continuative to the fourth input; and
provide, to the user terminal, third content by referring to the information about the third input,
wherein the third content corresponds to the third thumbnail image or the third enlarged image, and
the receiving of the information about the fourth input and the providing of the third enlarged image are repeatedly performed.

19. The content providing apparatus of claim 17, wherein the third input is an input on the display of the user terminal, and is one of an input including a plurality of different touch pressures, an input moving in one direction at at least a first speed, an input in which a plurality of inputs are repeated within a first time, and an input continued for a first period of time.

20. The content providing apparatus of claim 16, wherein the first input is an input on the display of the user terminal, and is one of an input including a plurality of different touch pressures and an input continued for a first period of time.
